(19) United States
(12) Patent Application Publication
(10) Pub. No.: US 2026/0205817 A1
(43) Pub. Date: Jul. 16, 2026

(54) Method for managing the connection to a network of a communicating object implemented by an interface device

(71) Applicant: ORANGE, ISSY LES MOULINEAUX (FR)

(72) Inventors: Mathieu RIVOALEN, Chatillon (FR); Hervé MARCHAND, Chatillon (FR)

(21) Appl. No.: 19/138,395

(22) PCT Filed: Dec. 12, 2023
(86) PCT No.: PCT/EP2023/085271

§ 371 Date: Jun. 12, 2025

(30) Foreign Application Priority Data
Dec. 19, 2022 (FR) FR2213806

(51) Int. Cl. H04W 12/088; H04L 9/40; H04W 12/126; H04W 12/63; H04W 76/18

(52) U.S. Cl. CPC H04W 12/088; H04L 63/18; H04W 12/126; H04W 12/63; H04W 76/18

(57) ABSTRACT

A method for managing the connection of a communicating object provided with an identifier to a network. The method includes the following steps implemented by an interface device between the communicating object and the network: following a request to connect the communicating object to the interface device, retrieving the identifier of the communicating object; comparing the retrieved identifier with at least one identifier stored in a database of searched objects; according to a result of the comparison, performing an action that relates to connecting the communicating object to the network, the action including notifying the objects connected to the interface device of a connection request of a communicating object whose identifier appears in the database of searched objects.

### TECHNICAL FIELD

The technical field is that of the management of communicating objects.

More precisely, the invention relates to a method for managing the connection to a network of a communicating object. This communicating object may be sought, in other words it may have been declared as lost or stolen by its owner who is seeking information about it.

The invention also relates to an interface device, such as a home gateway, implementing the management method according to the invention.

The communicating objects in question are equipments of any nature which dispose of a capacity for communicating according to a defined protocol. This may for example be a computer, portable or otherwise, which can connect to a local network via a wireless or wired connection, then by virtue of a gateway present in the local network, will be able to connect to the Internet. Such a computer may take the form of a tablet, reduced to a screen, using a touchscreen keyboard. It may also be a telephone that will connect to a telephone network, mobile or otherwise. This connection to a telephone network may subsequently allow the mobile telephone to also connect to the Internet. This mobile telephone is also referred to as a ‘smartphone’.

The communicating objects may also be objects dedicated to a precise function, which additionally dispose of means allowing them to connect to a local network then to the Internet in order to better carry out their function. This may for example be a surveillance camera which will be able to send its images via the Internet, a loudspeaker capable of acquiring music over the Internet, a car disposing of onboard communications means allowing it to acquire navigation information, a refrigerator able to order foodstuffs over the Internet when it has run out, a merchandise container disposing of a chip which will regularly upload information regarding its environment (temperature, potential movement) and the merchandise that it contains. In general, modern objects increasingly comprise means of communication allowing them to be connected to the Internet and may therefore be considered as communicating objects.

The access of the communicating objects to the Internet is by means of an interface device which provides the communicating object with the service for accessing the communications network. The interface device may be a home gateway which constructs a local network to which the communicating object belongs; from the local network, the communicating object can access a global network, such as the Internet, by virtue of the query processing and transfer services of the IP (acronym for Internet Protocol) protocol that the home gateway offers. The home gateway therefore has an interface between the communicating objects present in the local network and the entire global network. The interface device may also be a simple device for accessing a communications network, such as for example a base station giving a mobile telephone access to the mobile telephony network. The base station is then seen as constructing a local network limited to the mobile telephone connected to the station and offering an interface between this local network and a global telephony network or the Internet if the mobile telephone is a smartphone and disposes of the capacities for communication over this network.

### Prior Art

Communicating objects could to be lost or stolen, which is even more the case when they are portable objects, such as computers, tablets, smartphones, or objects such as connected loudspeakers, surveillance cameras. In this case, the owner of the object in question is going to be searching for it.

No general method exists allowing the communication capacities of the communicating objects to be used in order to defend against this risk. When a communicating object is stolen or lost, it could therefore be re-used by someone other than its rightful owner, including in its communication function.

Mobiles telecommunications operators have set up the possibility of declaring a mobile telephone theft. This declaration is made by informing them of the IMEI number of the telephone, which is a unique identifier of each mobile telephone. The telephone numbers thus declared may then be used by the telephony operators to prevent access to the telephony service by the telephones whose IMEI number is present on a centralized database in the network core of the mobile operator. However, this system does not prevent the stolen mobile telephone from being used through its capacities for connecting to local networks, for example via a wireless local network using the WiFi protocol. Moreover, the detection of a potential stolen telephone does not lead to any action by the mobile network operator aside from the impossibility of accessing the telephony network and does not trigger any actions relating to the localization of the telephone declared as stolen.

The company Apple has also provided a localization (FindMy™) and blocking (Lost Mode™) service or a service for deleting data from a terminal that is lost or assumed to be stolen. This service uses a service platform (iCloud™) which, based on an identifier declared by the user, will send a command to the terminal whose standard mode of operation is to regularly communicate with the iCloud service platform. This service therefore assumes that the terminal regularly connects to a dedicated service platform, and relies on actions implemented by the terminal. If such actions are not provided by the stolen object, because its data have been updated for example, or else it is a simple object not designed for that, the Apple anti-theft protection services will not work. The same is true if an action by the thief prevents the stolen object from connecting to the iCloud service platform.

There accordingly exists a need for a general protection in the case of loss or of theft applicable to all communicating objects, irrespective of the communication services that they are using and irrespective of the capacities of these communicating objects.

The invention is aimed at improving the situation.

### Description of the Invention

According to a first functional aspect, the invention relates to a method for managing the connection to a network of a communicating object having an identifier characterized in that the method comprises the following steps implemented by an interface device between the communicating object and the network:
Following a request for connection of the communicating object to the interface device, retrieve the identifier of the communicating object
Compare the identifier retrieved with at least one identifier stored in a database of objects being sought
Depending on the result of the comparison, carry out an action relating to the connection of the communicating object to the network, said action comprising a notification by the interface device to the communicating objects connected to the interface device of a connection request from a communicating object whose identifier appears in the database of objects being sought

By virtue of the invention, it is possible to implement protection actions for communicating objects being sought by their rightful owner, and to do this at the time when they request a connection to a network. These protection actions are implemented by the interface device which is responsible for the connection of the communicating object to the network. These protection actions being implemented by the interface device are applicable to any communicating object, for any communication protocol that this interface device is implementing. A stolen mobile telephone will therefore also be able to be blocked if it tries to connect to the Internet using WiFi via a home gateway. Furthermore, in this way, the localization of the communicating object at the time of its connection request may be taken into account by the protection action. In addition, the protection actions are not implemented by the communicating object in question and do not therefore require any special capacities on the part of the latter.

By virtue of the invention, a protection measure is implemented, namely the notification to other objects connected to the interface device of the connection request of a communicating object being sought. This will for example allow an administrator of a local network to receive a notification from the home gateway, which is creating this local network, that a communicating object being sought is to trying to connect over the local network that it is managing. This could be sent without blocking the connection of the communicating object being sought, hence in a discrete manner for this communicating object.

According to a first particular embodiment of the invention, the method additionally comprises the following steps:
Receive another communicating object identifier
Record in the database of objects being sought said other communicating object identifier received

In this embodiment, the interface device maintains a database of objects being sought by receiving identifiers of the communicating objects being sought. This receipt may come from a centralized platform or otherwise from a de-centralized system. One advantage of locating the database within the interface device is to allow an immediate reaction of the interface device to be implemented following a connection request from a connected object whose identifier is present in the database. Other embodiments are possible.

According to a second particular embodiment of the invention, which could be implemented alternatively or cumulatively with the preceding embodiment, the action comprises a refusal of the connection of the communicating object to the interface device.

By virtue of this embodiment, a first protection action consists in the blocking, by the interface device, of the connection of the communicating object. In this way, if it has been stolen, the communicating object loses its capacity as a communicating object which drastically limits the interest of the theft.

According to a third particular embodiment of the invention, which could be implemented alternatively or cumulatively with the preceding embodiments, the action comprises an acceptance of the connection of the communicating object to the interface device and to the network.

By virtue of this embodiment, the actions implemented by the interface device do not include the blocking of the connection of the communicating object to the network. In this way, protection actions may be implemented without the communicating object, assumed to be stolen, being informed since its connection takes place normally.

According to a fourth particular embodiment of the invention, which could be implemented alternatively or cumulatively with the preceding embodiments, the action comprises a notification by the interface device to a service platform situated within the network of a request for connection from a communicating object whose identifier appears in the database of communicating objects being sought.

By virtue of this embodiment, the interface device notifies a service platform of the connection request made by a communicating object being sought. This notification may take place whether the communicating object is finally connected or not to the network requested. This notification will allow other protection measures to be implemented such as informing the authorities, taking into account the location of the communicating object being sought, since it is the interface device which issues the initial notification. When the notification is issued while the connection of the communicating object is made by the interface device, the notification is issued in a discrete manner with respect to the communicating object.

According to a fifth particular embodiment of the invention, which could be implemented alternatively or cumulatively with the preceding embodiments, the database is situated within the network and is interrogated by the interface device following a connection request from a communicating object.

By virtue of this embodiment, the interface device does not need to maintain a database comprising the identifiers of objects being sought. This embodiment will therefore be easier to deploy, and the interface devices according to the invention will not comprise the memory needed to hold the database, which will allow resources to be saved. This embodiment has these advantages but has the drawback of adding a query from the interface device to a remote database during each connection request from a communicating object, which will lengthen the time for connection to the interface device for all the communicating objects, including those which are not sought.

According to a sixth particular embodiment of the invention, which could be implemented alternatively or cumulatively with the preceding embodiments, the identifiers of communicating objects compared are MAC addresses.

The MAC addresses are unique identifiers materially attached to all of the network cards used to create the network link of a communicating object. By using this identifier, the invention allows it to be ensured that all the categories of communicating objects could be sought and that the invention could be applied to them. Indeed, this identifier is universal and will be found in all communicating objects. Moreover, this identifier is easily obtained by an interface device, because a network command addressed by the interface device to the communicating object allows it to be obtained.

According to a seventh particular embodiment of the invention, which could be implemented alternatively or cumulatively with the preceding embodiments, the identifiers of communicating objects compared are IMEI numbers.

The IMEI number is an identifier attached to mobile telephones. By virtue of this embodiment, the invention may be applied when the communicating object being sought is a mobile telephone which tries to connect to a mobile telephony network.

According to a first hardware aspect, the invention relates to an interface device between a communicating object having an identifier and a network implementing a method for managing the connection of the communicating object to the network characterized in that said interface device comprises the following modules:
A retrieval module designed to retrieve the identifier of the communicating object following a request for connection of the communicating object to the interface device
A comparison module designed to compare the identifier retrieved with at least one identifier stored in a database of objects being sought
A module designed to implement an action depending on the comparison, said action comprising a notification by the interface device to the communicating objects connected to the interface device of a connection request from a communicating object whose identifier appears in the database of objects being sought
A connection module designed to connect the communicating object to the interface device and to the network

According to another hardware aspect, the invention relates to an interface device between a communicating object having an identifier and a network implementing a method for managing the connection of the communicating object to the network, additionally comprising the following modules:
A receiver module designed to receive another communicating object identifier
A recording module designed to record, in a database of communicating objects being sought, said other communicating object identifier received

According to another hardware aspect, the invention relates to a home gateway between a local network and the network of the Internet type which comprises an interface device according to the invention.

By virtue of this aspect, the invention may be applied to any type of communicating object which tries to connect to the Internet through an interface device such as a home gateway. This aspect is particularly adapted when the identifier used is the MAC address of the communicating object being sought.

According to another hardware aspect, the invention relates to a base station of a mobile telephony network which comprises an interface device according to the invention.

By virtue of this aspect, the invention is applicable to the search for a stolen mobile telephone and is particularly adapted when the identifier used is an IMEI number.

According to another hardware aspect, the invention relates to a computer program designed to be implemented by an interface device, the program comprising code instructions which, when it is executed by a processor, carries out the steps of the method according to the invention for managing the connection to a network of a communicating object.

According to another hardware aspect, the invention relates to a data medium on which a computer program is recorded comprising a sequence of instructions for the implementation of the management method according to the invention when it is loaded into and executed by a processor.

The data media may be any given entity or device capable of storing the programs. For example, the media may comprise a storage means, such as a ROM, for example a CD ROM or a microelectronic circuit ROM, or else a magnetic recording means such as a hard disk. On the other hand, the media may be transmissible media such as an electrical or optical signal, which may be carried via an electrical or optical cable, by radio or by other means. The programs according to the invention may in particular be up/downloaded over a network of the Internet type. Alternatively, the information medium may be an integrated circuit into which the program is incorporated, the circuit being designed to execute, or to be used in the execution of, the method in question.

### BRIEF DESCRIPTION OF THE FIGURES

The invention will be better understood from reading the description that follows, given by way of example and with reference to the appended drawings, namely:

FIG. 1 shows an interface device according to the invention, providing the connection of a communicating object present in a local network to a global network.

### DETAILED DESCRIPTION

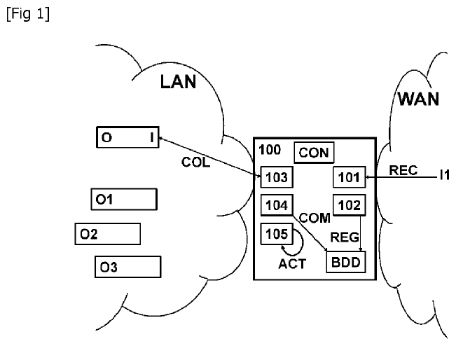

FIG. 1 shows one example of an interface device 100 providing the connection of communicating objects present in a local network LAN (for Local Area Network) to a wide-area communications network (or WAN). The local network LAN comprises communicating objects O1, O2, O3 which are attached to this network LAN through the interface device 100.

The interface device 100 may for example be a home gateway which, on the one hand, creates a local network LAN in which communicating objects O1, O2, O3 can communicate with one another and, on the other hand, forms the connection of the communicating objects O1, O2, O3 present in the network LAN with a wide-area communications network WAN such as for example the Internet. The local network LAN may be created by the device 100 by deploying a wireless communications protocol such as WiFi or else by providing wired communications between the communicating objects O1, O2, O3 and itself. The interface device 100 then plays a role of router for the local network LAN. The device 100 also provides the connection of the communicating objects O1, O2, O3 to the wide-area communications network WAN, in general the Internet in the case of a home gateway. However, the network WAN may also be a corporate network and the interface device 100 a gateway in charge of managing a local network LAN over one of the sites of the company.

The interface device 100 may also be a base station of a mobile telephony network. In this case, the interface device does not maintain a local network LAN for several communicating objects but it may be considered that it creates a local network LAN for a communicating object which connects to the device 100. This network LAN will be exclusively used for the communication between a communicating object, which is a mobile telephone, and the device 100 which is a base station, the device 100 also providing the access for the mobile telephone to the telephony network WAN.

The interface device 100 has the hardware architecture of a conventional computer. It notably comprises a processor, a volatile memory of the RAM type and a non-volatile memory such as a memory of the type Flash, ROM, etc. (not shown in the figure). The device 100 may have input-output devices such as buttons, keyboards, screens (not shown in the figure) but this is not a general obligation, since the interface device 100 is generally dedicated to the provision of the interfacing service between the two networks LAN and WAN and does not always need to interact with users.

In any case, the interface device 100 comprises a connection module CON designed to connect a communicating object having an identifier to the interface device 100 and to the network WAN. The connection module CON fulfils all of the expected functions of the interface device 100 independently of its implementation of the invention.

In the present example, the interface device 100 comprises a receiver module 101 designed to receive REC another communicating object identifier I1, but other embodiments are possible not comprising this module.

In the present example, the interface device 100 comprises a recording module 102 designed to record REG said other communicating object identifier I1 received REC in a database BDD of communicating objects being sought, but other embodiments are possible not comprising this module.

The interface device 100 comprises an retrieval module 103 designed to retrieve COL the identifier I of a communicating object O following a request for connection of the communicating object O to the interface device 100.

The interface device 100 comprises a comparison module 104 designed to compare COM the identifier I retrieved COL with at least one identifier I1 stored in a database BDD of objects being sought.

The interface device 100 comprises a module 105 designed to implement an action ACT depending on the comparison COM, said action ACT comprising a notification by the interface device to the communicating objects O1, O2, O3 connected to the interface device 100 of a connection request from a communicating object O whose identifier I appears in the database of objects being sought.

In the present example, the method according to the invention starts with a step REC for receiving a communicating object identifier I1. This step REC is implemented by the module 101 of the interface device 100.

The identifier I1 in question is that of a communicating object being sought by its rightful owner. The object in question may be lost or may have been stolen. A service platform, whose details are not further described, has been set up to allow a user of the service to declare an identifier I1 of a communicating object being sought. This service platform will allow the interface device 100 to receive REC the identifier I1 of a communicating object being sought. This receiving step REC may be implemented upon the initiative of the service platform which will submit the identifier I1 to the interface device 100 or else upon the initiative of the interface device 100 which may regularly request from the service platform which are the identifiers I1 of communicating objects being sought. This distinction does not matter in the context of the invention, and the device 100 according to the invention may implement the receiving step REC in these two ways.

The method according to the invention will see its efficiency increase with the number of interface devices 100 implementing the invention. A telecommunications operator will thus be able to implement the invention in all of the home gateways that it supplies to its customers for accessing the Internet, and also in the base stations of the mobile telephony network that it is operating.

The identifier I1 depends on the nature of the communicating object being sought. A communicating object disposes of a network card in order to carry out the communication operations specific to its nature as a communicating object and hence disposes of a MAC address attached to the network card. This MAC address may therefore be an identifier I1 of the communicating object being sought for the entirety of the communicating objects. In the case where the communicating object being sought is a mobile telephone, its IMEI number may be an identifier. Other identifiers may be received REC.

In the present example, the interface device 100 subsequently carries out a step REG for recording the identifier I1 in a database BDD of objects being sought. The recording operation REG allows the interface device 100 to dispose of an updated database BDD of identifiers of objects being sought. The database BDD may be a relational database implemented using the query language SQL (for Structured Query Language) or, on the contrary, an object-riented database not using the basic principles of relational data (databases referred to as “NoSQL”) or else be limited to a file recorded in the volatile or non-volatile memory of the interface device 100 in which the relevant information is recorded.

Other operations, not described, allow identifiers to be removed from the database BDD when the communicating objects corresponding to the identifiers are no longer sought for whatever reason. These steps for updating the database BDD do not have any particularities specific to the invention and are not detailed further here.

In some embodiments, the database BDD is recorded in the interface device 100, in a memory area of the interface device 100, and is accessible directly by queries executed by the interface device 100. In other embodiments, the database BDD is not recorded in the interface device but is hosted by a device which may be accessed via the communications network WAN. This device may be a conventional server or else a server deployed within a cloud computing architecture. In these embodiments, the interface device 100 does not have to record REG the first identifier I1. It is a centralized service platform which is responsible for updating the BDD of objects being sought. The interface device 100 receives, in the framework of its usual operation as interface device, connection requests from communicating objects. When the interface device 100 receives a request for connection of the communicating object O, it will perform a step COL for retrieving an identifier I of the communicating object O. In order to retrieve an identifier I which is a MAC address, the interface device 100 just needs to address a network command specific to the communicating object O, such as a “ping” command. In response to this command, the communicating object O supplies its MAC address which is therefore retrieved COL by the interface device 100.

The following step of the method then consists, for the interface device, in comparing COM the identifier I retrieved COL with an identifier I1 stored in a database BDD of objects being sought. In some exemplary embodiments, the identifier I1 has been received REC then recorded REG in the database BDD of objects being sought by the interface device 100. In general, the comparison step COM will not be applied to a single identifier I1 but indeed to all the identifiers recorded REG in the database BDD during the operation of the interface device 100, taking into account the updates of the database BDD.

In the embodiments where the database BDD is not hosted by the interface device 100, the comparison operation consists of a remote query of the database BDD. This query takes place via the communications network WAN.

Depending on the result of the comparison operation COM, the interface device 100 will or will not carry out a specific action ACT of the method according to the invention.

If the comparison operation COM reveals that the identifier I of the communicating object O does not correspond to any of the identifiers recorded REG in the database BDD, the device 100 will carry out a request for connection of the communicating object O as expected from the standard operation of the interface device 100. This connection request will then be processed by the module CON dedicated to this function of the interface device 100. In this case, the interface device 100 will not implement a specific action ACT of the method according to the invention.

On the contrary, if the comparison operation COM reveals that the identifier I of the communicating object O corresponds to the identifier of an object being sought because it is present in the database BDD, the device 100 will carry out an action ACT specific to the method according to the invention. The action ACT in question may take several forms depending on the embodiments of the method according to the invention. The action ACT comprises a notification by the device 100 to the other communicating objects O1, O2, O3 present in the local network LAN of the connection request from an object O that is potentially stolen. If the device 100 is a home gateway providing the possibility of access to the network WAN for a public place such as a hotel, a restaurant, a place of transit such as a station or an airport, the notification may enable an attempt to find the potentially stolen object O. This notification must not be sent to the object O in question and may be combined with a refusal or with an acceptance of the connection of the object O to the network WAN.

In one embodiment, the action ACT comprises the refusal by the device 100 of the connection of the communicating object O. The communicating object O will not then be able to connect to the device 100 nor a fortiori to the networks LAN and WAN to which the device 100 provides access. In this way, the communicating object O is no longer usable as a communicating object. If it has been stolen, as indicated by the presence of the identifier I in the database BDD of objects being sought, the object O will therefore no longer be usable in its communication function. The blocking action ACT comprising a connection refusal is therefore a dissuasive action with regard to the theft of communicating objects.

In another embodiment, the action ACT comprises an acceptance by the device 100 of the connection of the communicating object O. This acceptance will subsequently be able to allow the communicating object O to access the network WAN. The advantage of this embodiment may be not to notify the person in possession of the communicating object O, who is potentially its thief, that the object O has indeed been identified as belonging to the database BDD of objects being sought. By allowing the object O to proceed with its connection, the person in possession of the object O is not alerted by it being blocked.

In other embodiments, the action ACT comprises notifications of the request for connection of the object O to the interface device 100. If the action ACT comprises an acceptance of the connection of the object O, these notifications are sent without alerting the person in possession of the object O which is potentially stolen. One possible notification in the framework of the action ACT carried out by the device 100 is to notify a service platform of the request for connection of the object O to the device 100. This service platform may be in communication with the one which has supplied the first identifier I1 of a communicating object being sought. By indicating that the communicating object O has an identifier belonging to the database BDD of objects being sought, the device 100 warns that an object being sought is trying to connect to the device 100 and, more generally, to the network WAN. The device 100 may also supply its location and this information will allow the manager of the service platform to take further measures to find the potentially stolen object O, together with the person (potentially the thief) currently in possession.

In some embodiments, the identifiers I and I1 are MAC addresses. MAC addresses are present on all the communicating objects because they are allocated to each network card, hence to any communicating object. Portable computers could therefore be identified and located by an interface device 100 according to the invention. A connected vehicle could also be identified and located by an interface device 100 according to the invention when it passes close to the local network LAN created by the interface device 100. Home objects such as connected cameras, connected loudspeakers, connected televisions could also be identified and located by interface devices 100 according to the invention. If the connected object O is a portable telephone or a tablet trying to connect to the device 100 by virtue of the WiFi protocol, a device 100 according to the invention which fulfils the role of home gateway will also be able to identify and locate the communicating object O. These examples show the general scope of the invention, which is a clear advantage.

In other embodiments, the identifiers I and I1 are IMEI numbers. These embodiments allow the invention to be applied to the search for mobile terminals or smartphones trying to connect to a mobile telephony network. The interface device 100 then plays the role of base station of the mobile telephony network.

By virtue of the invention, it is therefore possible to implement protection actions allowing the communication functions of lost or stolen communicating objects to be blocked and also their location to be notified. The notification may take place without alerting the person in possession of the lost or stolen communicating object O if the action ACT does not comprise the blocking of the connection request. The invention does not assume any action carried out by the lost or stolen object and may therefore be applied to all the categories of communicating objects, irrespective of their functionalities and manufacturers. Another advantage is that the method is implemented by the interface device 100 to which the communicating object O connects, and the method may therefore dispose of quite precise information on location of the communicating object O. The location of the communicating object O may be approximated by the location of the interface device 100 to which the object O tries to connect.

It is lastly highlighted here that, in the present text, the term “module” may correspond both to a software component as well as to a hardware component or to an assembly of software and hardware components, a software component itself corresponding to one or more computer programs or sub-programs or, more generally, to any element of a program designed to implement a function or a set of functions such as described for the modules in question. In the same way, a hardware component corresponds to any element of a hardware assembly designed to implement a function or a set of functions for the module in question (integrated circuit, smart card, memory card, etc.).

1. A management method for managing a connection to a network of a communicating object having an identifier, wherein the method is implemented by an interface device between the communicating object and the network and comprises:
following a request for connection of the communicating object to the interface device, retrieving the identifier of the communicating object;
comparing the identifier retrieved with at least one identifier stored in a database of objects being sought; and
depending on a result of the comparison, carrying out an action relating to the connection of the communicating object to the network, said action comprising a notification by the interface device to communicating objects connected to the interface device of the request for connection of the communicating object whose identifier appears in the database of objects being sought.

2. The management method as claimed in claim 1, wherein the method furthermore comprises:
receiving another communicating object identifier;
recording in the database of objects being sought said other communicating object identifier received.

3. The management method as claimed in claim 1, wherein the action comprises a refusal of the connection of the communicating object to the interface device.

4. The management method as claimed in claim 1, wherein the action comprises an acceptance of the connection of the communicating object to the interface device and to the network.

5. The management method as claimed in claim 1, wherein the action comprises a notification by the interface device to a service platform situated within the network of the connection request from the communicating object whose identifier appears in the database of communicating objects being sought.

6. The management method as claimed in one claim 1, wherein the database is situated within the network and is interrogated by the interface device following the connection request from the communicating object.

7. An interface device connectable between a communicating object having an identifier and a network, the interface device comprising:
at least one processor; and
at least one non-transitory computer readable medium comprising program code instructions stored thereon which when executed by the at least one processor configure the interface device to manage a connection to the network of the communicating object by:
retrieving the identifier of the communicating object following a request for connection of the communicating object to the interface device;
comparing the identifier retrieved with at least one identifier stored in a database of objects being sought;
implementing an action depending on the comparison, said action comprising a notification by the interface device to communicating objects connected to the interface device of the connection request from the communicating object whose identifier appears in the database of objects being sought; and
connecting the communicating object to the interface device and to the network.

8. The interface device as claimed in claim 7, the instructions further configure the interface device to:
receive another communicating object identifier;
record, in a database of communicating objects being sought, said other communicating object identifier received.

9. A home gateway connectable between a local network and the network, which is of the Internet type, wherein the home gateway comprises the interface device as claimed in claim 7.

10. A base station of the network, which is a mobile telephony network, wherein the base station comprises the interface device as claimed in claim 7.

11. (canceled)

12. A non-transitory computer readable data medium on which a computer program is recorded comprising a sequence of instructions for implementation of the management method as claimed in claim 1 when the computer program is loaded into and executed by a processor.
